(19) United States
(12) Patent Application Publication
(10) Pub. No.: US 2022/0125174 A1
(43) Pub. Date: Apr. 28, 2022

(54) BOOK BAG WITH LED LIGHTS

(71) Applicant: Mia Jonelle Abbott, New Orleans, LA (US)

(72) Inventor: Mia Jonelle Abbott, New Orleans, LA (US)

(21) Appl. No.: 17/302,007

(22) Filed: Apr. 21, 2021

Related U.S. Application Data
(60) Provisional application No. 63/105,659, filed on Oct. 26, 2020.

(51) Int. Cl. A45C 15/06; F21S 4/22; F21V 23/00; F21S 9/02; A45C 3/06; A45F 3/04

(52) U.S. Cl. CPC A45C 15/06; F21S 4/22; F21V 23/001; F21Y 2115/10; A45C 3/06; A45F 3/04; F21S 9/02

(57) ABSTRACT

An illuminated bag or handbag is provided, comprising a plurality of light emitting diodes distributed in a predetermined pattern on a substrate layer and covered with a transparent exterior layer.

### CROSS-REFERENCE TO RELATED APPLICATION

This application claims the benefit of priority of U.S. provisional application No. 63/105,659, filed Oct. 26, 2020, the contents of which are herein incorporated by reference.

### BACKGROUND OF THE INVENTION

The present invention relates to a bag and, more particularly, to a book bag having light emitting diode (LED) lights.

Many accidents occur at night when a driver cannot see a pedestrian or bicyclist, affecting thousands of families when a loved one passes away. People who may work late and take a bus, ride a bike, or walk home need a sense of safety knowing they are seen, such as to avoid being hit by a car. Increased visibility is also necessary for the safety of children, such as when leaving for or returning from school, and for the peace of mind of parents and drivers.

As can be seen, there is a need for a device that increases visibility of a pedestrian or bicyclist.

The present invention provides a book bag with light emitting diodes (LEDs), which may increase visibility for any activities. Drivers look even if just to see the pretty bag. The inventive bag also serves as a fashion accessory for boys, girls, men, and women who love to be seen. The inventive bag is also advantageous for use in sports arenas where entry may be allowed only with clear bags.

### SUMMARY OF THE INVENTION

In one aspect of the present invention, an illuminated bag is provided, comprising a plurality of light emitting diodes distributed in a predetermined pattern on a substrate layer and covered with a transparent exterior layer.

In another aspect of the present invention, an illuminated handbag is provided, comprising a plurality of individual light emitting diodes distributed in a predetermined pattern on a substrate layer and covered with a transparent exterior layer.

These and other features, aspects and advantages of the present invention will become better understood with reference to the following drawings, description, and claims.

### BRIEF DESCRIPTION OF THE DRAWINGS

FIG. 1 is a perspective view of a backpack according to an embodiment of the present invention;

FIG. 2 is a perspective view thereof;

FIG. 3 is a detail perspective view of a light strip thereof, taken at location 3-3 of FIG. 2;

FIG. 4 is a detail cross-sectional view taken at line 4-4 of FIG. 3;

FIG. 5 is a perspective view of a backpack according to another embodiment of the present invention; and

FIG. 6 is a perspective view of a handbag according to another embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, directional terms such as upper, lower, upward, downwardly, top, left, right and the like are used in relation to the illustrative embodiments as they are depicted in the figures, such that the upward direction (or upper) being toward the top of the corresponding figures and the downward direction being toward the bottom of the corresponding figures.

Broadly, one embodiment of the present invention is a transparent illuminated book bag, backpack, or handbag with a plurality of LEDs in a predetermined pattern.

The LEDs may be placed in a variety of locations, such as along the zipper(s), at the top of the bag, and around the trim of the bag. In some embodiments, the LEDs may be arranged in a light-up cartoon, such as lipstick. In some embodiments, the LEDs may be provided in a variety of colors to increase visibility.

The LEDs may be distributed on a substrate layer and covered with a transparent or translucent layer. In some embodiments, the substrate is transparent or translucent as well.

In some embodiments, a video camera is also provided.

The inventive bags are preferably manufactured of materials that are easy to clean and resist staining.

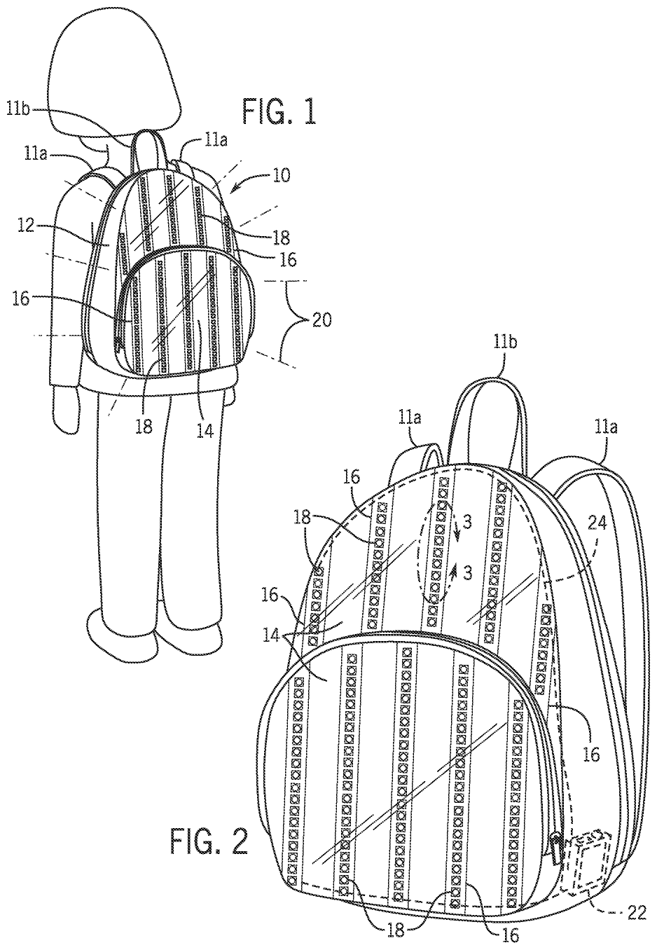

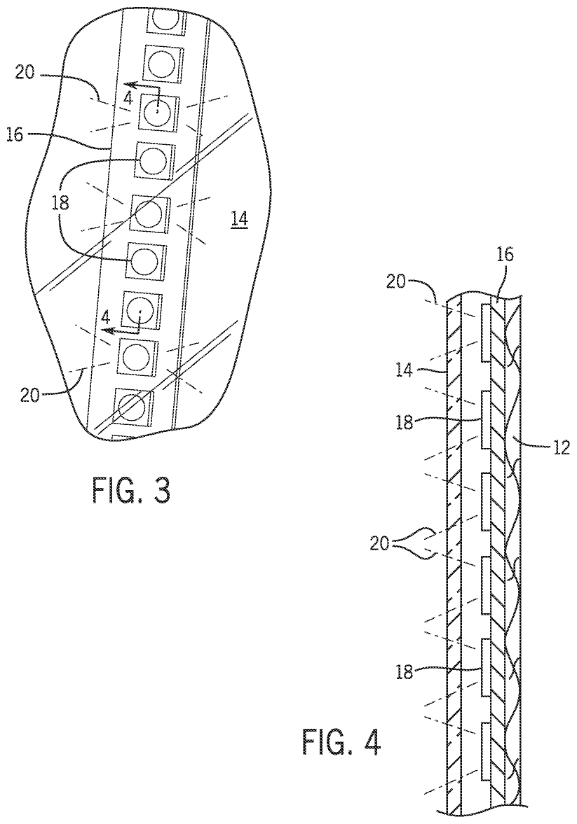

Referring to FIGS. 1 through 6, FIG. 1 shows a transparent illuminated backpack 10 according to an embodiment of the present invention, including shoulder straps 11a and a carrying strap 11b attached to a backpack body 12. The backpack 10 has a transparent exterior layer 14 covering evenly distributed, vertically oriented light strips 16, comprising LED lights 18 distributed there along, attached to the backpack body 12, as shown in FIGS. 3 and 4. The light strips 16 are operative to emit light rays 20 when powered by a power source or power pack 22 by way of wiring 24, as shown in FIG. 2.

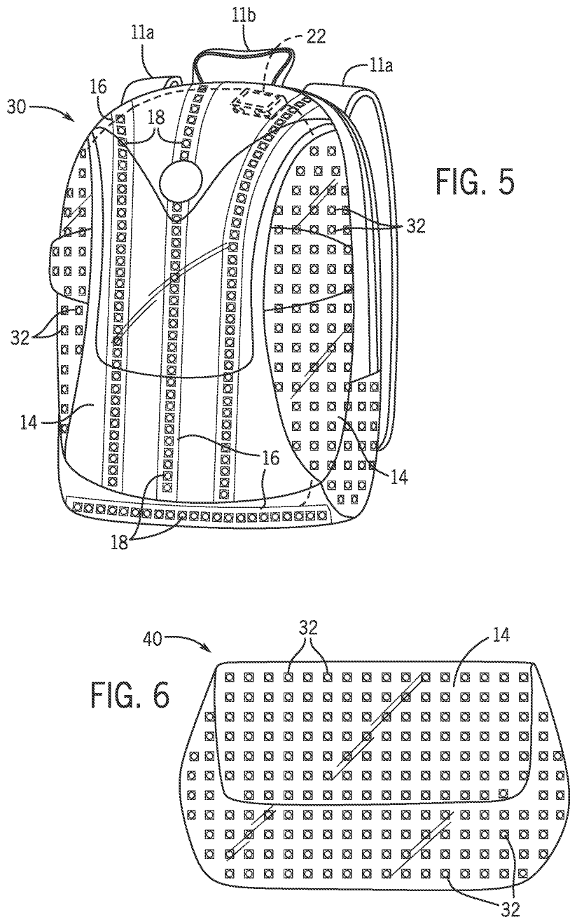

FIG. 5 shows a backpack 30 according to another embodiment of the present invention, having individual light emitting diodes 32 in addition to light strips 16.

FIG. 6 shows a handbag 40 according to another embodiment of the present invention, having individual light emitting diodes 32.

It should be understood, of course, that the foregoing relates to exemplary embodiments of the invention and that modifications may be made without departing from the spirit and scope of the invention as set forth in the following claims.

1. An illuminated bag, comprising a body having a base, sidewalls, and a closable top forming at least one compartment;
wherein at least one surface of the illuminated bag has an interior substrate layer, a transparent exterior layer, and a plurality of light emitting diodes distributed in a predetermined pattern therebetween, with the plurality of light emitting diodes attached to the interior substrate layer.

2. The illuminated bag of claim 1, further comprising wiring and a power source electrically communicating with the plurality of light emitting diodes via the wiring.

3. The illuminated bag of claim 1, wherein the interior substrate layer is transparent.

4. The illuminated bag of claim 1, wherein the illuminated bag is a backpack comprising shoulder straps and a carrying strap.

5. The illuminated bag of claim 1, wherein the light emitting diodes emit light in a variety of colors.

6. The illuminated bag of claim 1, wherein the light emitting diodes are distributed along light strips and are attached via the light strips to the interior substrate layer.

7. The illuminated bag of claim 6, wherein the body further comprises a zipper and the light strips are operative to illuminate the zipper.

8. The illuminated bag of claim 6, wherein the light strips are operative to illuminate the closable top of the illuminated bag.

9. The illuminated bag of claim 6, wherein the light strips are operative to illuminate trim on the illuminated bag.

10. The illuminated bag of claim 6, wherein the light strips are vertically oriented and evenly distributed.

11. The illuminated bag of claim 6, further comprising individual light emitting diodes.

12. The illuminated bag of claim 6, further comprising individual light emitting diodes, wiring, and a power source electrically communicating with the plurality of light emitting diodes via the wiring, wherein the illuminated bag is a backpack comprising shoulder straps and a carrying strap, the interior substrate layer is transparent, the light strips are vertically oriented and evenly distributed, and the light emitting diodes emit light in a variety of colors.

13. An illuminated clutch bag comprising a body having an elongated base, sidewalls, and a foldable top operative to overlap one of the sidewalls, forming at least one compartment;
wherein at least one surface of the illuminated clutch bag has an interior substrate layer, a transparent exterior layer, and a plurality of individual light emitting diodes distributed in a predetermined pattern therebetween, with the plurality of individual light emitting diodes attached to the interior substrate layer.

14. The illuminated clutch bag of claim 13, further comprising wiring and a power source electrically communicating with the plurality of individual light emitting diodes via the wiring.

15. The illuminated clutch bag of claim 13, wherein the interior substrate layer is transparent.
